(19) United States
(12) Patent Application Publication
(10) Pub. No.: US 2026/0135129 A1
(43) Pub. Date: May 14, 2026

(54) FUEL CELL SYSTEM AND OPERATING METHOD FOR A FUEL CELL SYSTEM

(71) Applicant: Robert Bosch GmbH, Stuttgart (DE)

(72) Inventors: Jonas Breitinger, Stuttgart (DE); Matthias Rink, Herrenberg (DE); Daniel Deifel, Sindelfingen (DE)

(21) Appl. No.: 19/118,046

(22) PCT Filed: Oct. 11, 2023
(86) PCT No.: PCT/EP2023/078191

§ 371 Date: Apr. 3, 2025

(30) Foreign Application Priority Data
Oct. 12, 2022 (DE) 10 2022 210 735.7

(51) Int. Cl. H01M 8/04746; H01M 8/0438; H01M 8/04828

(52) U.S. Cl. CPC H01M 8/04761; H01M 8/04388; H01M 8/04828

(57) ABSTRACT

The present invention relates to a fuel cell system (100) for converting energy. The fuel cell system (100) comprises:
a fuel cell stack (101) which comprises a cathode subsystem (103) and an anode subsystem (105),
a pressure sensor (107) which is arranged in the anode subsystem (105),
a flush valve (109) for purging the anode subsystem (105),
a computing unit (111),
   the computing unit (111) being configured to determine a composition of a gas which is flowing through the anode subsystem (105) by means of measured values acquired by the pressure sensor (107) and to control the flush valve (109) according to the determined composition.

### BACKGROUND

The present invention relates to a fuel cell system for converting energy and an operating method for a fuel cell system according to the disclosure.

Hydrogen-based PEM fuel cells are considered to be the mobility concept of the future, because they only emit water as exhaust gas and enable fast fueling times.

PEM fuel cells are typically built with a closed anode loop allowing recirculation of the flowing gas.

As a result, optimal use of the supplied hydrogen can be configured despite the hyperstoichiometric operation of the anode, as provided to prevent locally insufficient supply of the reactant.

In addition, diffusing water may be recirculated in vapor form from the cathode side to the anode to guarantee sufficient moistening of the membrane at the anode entry.

Both during operation and when switched off, nitrogen diffuses through the membrane from the cathode side to the anode side. This leads to nitrogen accumulation in the anode circuit, which increases the recirculation power required. At the same time, the hydrogen partial pressure, and thus the local maximum diffusion flow of hydrogen through the GDL, decreases. This may lead to local areas of hydrogen depletion resulting in irreversible damage to the catalyst layer.

Nitrogen transfer is difficult to estimate because it is strongly dependent on the operating point and aging of the membrane.

Excessive accumulation is avoided with a “flush”, that is to say the removal of anode gas through a corresponding so-called “flush valve”. Nitrogen-containing gas is thus removed from the anode circuit, and fresh hydrogen is added, thereby decreasing the relative substance quantity fraction of nitrogen.

When a fuel cell system is operated, liquid water generated can also be removed via so-called “drain valve” or together with the gas mixture via a joint flush/drain valve.

Typically, the flush and exhaust valves are configured as switching valves for cost reasons, which are periodically opened and closed.

A measurement or calculation of the current gas composition in the anode circuit is required to optimize the flushing strategy, i.e. the opening and closing of the flush valve as a function of the operating point. Only in this way can minimization of the required recirculation capacity, adherence to the minimum partial pressure of the hydrogen and avoid excessive hydrogen loss, i.e. maximization of system efficiency, be achieved.

In principle, the direct measurement of the gas composition is possible via corresponding sensor technology. However, sensors required for this are expensive and require a large amount of design space.

### SUMMARY

The present invention discloses a fuel cell system and an operating method for operating the fuel cell system. Further features and details of the invention arise from the respective dependent claims, the description, and the drawings. In this context, features and details described in connection with the operating method according to the invention clearly also apply in connection with the fuel cell system according to the invention, and respectively vice versa, so that mutual reference to the individual considerations of the invention always is or can be made with respect to the disclosure.

The present invention serves in particular to provide a robust and fuel efficient fuel cell system.

Therefore, according to a first aspect of the present invention, a fuel cell system for converting energy is presented.

The fuel cell system comprises a fuel cell stack comprising a cathode subsystem and an anode subsystem, a pressure sensor arranged in the anode subsystem, a flush valve for flushing the anode subsystem, and a computing unit. The computing unit is configured to determine a composition of gas flowing through the anode subsystem by means of measured values acquired by the pressure sensor, and to control the flush valve as a function of the substance quantity fractions.

In the context of the invention presented, a computing unit is understood to mean a computer, a processor, a control device, or any other programmable circuit.

The invention presented is based on the principle that a pressure curve in the anode subsystem of a fuel cell system is used to determine a composition of a gas flowing in the anode subsystem. With a known composition of a gas flowing in the anode subsystem, the flush valve of the fuel cell system may be optimized, i.e., shortened, actuated, opened, if necessary, so as to provide particularly fuel efficient operation of the fuel cell system.

In a simplified manner, at the time of the flushing operation, the anode subsystem can be viewed as a volume under pressure, from which a gas mixture is discharged through the flush valve. Critical flow typically first occurs through the valve at the narrowest the diameter (area A). The resulting mass flow ∘ through the flush valve is calculated in good proximity to equation (1).

$$\dot{m} = A \sqrt{2 ρ P} Ψ \qquad ( 1 )$$

In equation (1) and denote the density and the total pressure, respectively, of the gas mixture in the anode circuit. denotes the outflow function and is constant in case of critical flow.

Assuming an ideal gas mixture, the mass m of the gas mixture in the anode circuit is calculated with equation (2)

$$m = pV / RT \qquad ( 2 )$$

In equation (2), denotes the volume of the anode circuit, T denotes the temperature in the anode circuit and the specific gas constant of the gas mixture. The specific gas constant, and thus the density, are strongly dependent on the composition of the gas. By means of mass maintenance according to equation (3),

$$( 1 ) m ( t ) = {m}_{0} - {\int }_{t 0}^{t} \dot{m} d t \qquad ( 3 )$$

the pressure curve in the anode circuit can now be determined during flushing using a differential equation (4):

$$p ( t ) = {p}_{0} - \sqrt{2} \frac{A R Ψ T ( t )}{V} {\int }_{t 0}^{t} \sqrt{ρ ( t ) P ( t )} d t \qquad ( 4 )$$

State 0 designates the variables at the time before the starting the flushing operation. The changes in temperature and density in the anode circuit may be considered adiabatic expansion according to equations (5) and (6).

$$T ( t ) = {{T}_{0} ( \frac{{p}_{0}}{p ( t )} )}^{\frac{1 - K}{K}} \qquad ( 5 )$$

$$ρ ( t ) = \frac{p ( t ) V}{RT ( t )} \qquad ( 6 )$$

The water vapor content was neglected in the above consideration. At conventional operating points, full saturation of the gas phase occurs at the anode outlet. The water partial pressure is thus known in the gas phase at the measured temperature.

The computing unit may be configured to increase the period of time the flush valve is activated compared to a prescribed standard value, or to decrease the period of time that the flush valve is closed compared to a prescribed standard value, if a substance quantity fraction in the gas lies above a specified threshold value.

In order to reduce a high substance quantity fraction of nitrogen in the anode subsystem, the flush valve may be activated, i.e., opened, for longer and/or more often.

The computing unit may further be configured to decrease the period of time the flush valve is activated compared to a prescribed standard value, or to increase the period of time that the flush valve is closed compared to a prescribed standard value, if a substance quantity fraction of hydrogen in the gas lies above a specified threshold value.

In order to minimize or prevent the discharge of hydrogen through a flushing operation, an activation action period, during which the flush valve is to be activated may be decreased compared to a prescribed standard value or a closing period, during which the flush valve is to be closed may be increased if the substance quantity fraction of hydrogen is above a specified threshold value.

The computing unit may be further configured to associate measured values acquired by the pressure sensor with a respective curve from among a predetermined plurality of curves for different compositions of gases.

By using a plurality of predetermined pressure curves over time in the anode subsystem, each associated with a specific gas composition, respective determined measured values can be mapped to a corresponding curve by, for example, selecting the curve whose value or values comes closest to the respective measured value or values out of all of the curves.

The computing unit may be further configured to calculate a quantity of hydrogen flowing into the anode subsystem based on a position of a hydrogen dosing valve, a pressure differential between a position upstream of the hydrogen dosing valve to a position downstream of the hydrogen dosing valve, and the diameter of the area through which the inflowing hydrogen flows.

Typically, the position of the hydrogen dosing valve or HGI (Hydrogen Gas Injector), which regulates an inflow of fresh hydrogen into the anode subsystem, is used for pressure regulation in the anode subsystem. Thus, potentially mechanically damaging pressure differentials across the membrane can be avoided.

The computing unit may be further configured to adjust the quantity of hydrogen flowing into the anode subsystem as a function of a substance quantity fraction of nitrogen in a gas flowing through the anode subsystem.

In the case of a high nitrogen concentration, a lower quantity of hydrogen must be supplied in order to maintain a specified, non-harmful pressure level or vice versa in the case of a low nitrogen concentration. The fuel cell system presented determines a mass flow of hydrogen through the hydrogen dosing valve based on the pressure differential through the hydrogen dosing valve and the diameter of the area through which it flows, as a function of a valve position of the hydrogen dosing valve. The valve geometry and the material behavior of pure hydrogen are assumed to be known.

The fuel cell system may further comprise a drain valve for draining water from the fuel cell system, and a hydrogen dosing valve, wherein the computing unit is configured to determine a quantity of liquid water located in the anode subsystem based on a time curve of opening of the hydrogen dosing valve during activation of the drain valve.

In a fuel cell system with a drain valve, in particular with a combined so-called flush/drain valve, a majority of liquid water or a two-phase gas mixture is discharged immediately after opening the valve. Due to the initially higher density, pressure in the anode subsystem does not change linearly, so that a delay or even a direction reversal in the pressure curve can occur when initially pure water flows through the drain valve. Only when the liquid water has flowed out and the gas phase dominates in the anode subsystem or the drain valve, respectively, can a pressure curve as described above be determined and mapped.

The computing unit may be further configured to activate the flush valve and/or the drain valve as a function of a determined quantity of liquid water.

To adjust to a specified quantity of liquid water in the fuel cell system, the flush valve and/or the drain valve may be activated as long and/or as often as needed until the determined quantity of liquid water corresponds to the specified quantity of liquid water.

The computing unit may be further configured to evaluate the determined quantity of liquid water over time, and in the event the determined quantity of liquid water decreases by more than a predetermined threshold value over time, to issue an error message, which includes a notification about the disturbance of water transport characteristics of the fuel cell system, and/or to adjust operating parameters of the fuel cell system as a function of the determined quantity of liquid water.

Determination of the quantity of liquid water may be used to adjust the duration of a flushing operation or the frequency of flushing operations and/or to analyze water transport through the membrane of the fuel cell system. With varying water transport characteristics over the life of the fuel cell system, excessive degradation of the water transport may be observed and countermeasures taken. For example, operating parameters, in particular pressure and stoichiometry in the cathode subsystem, can be adjusted to the new water transport characteristics or, in extreme cases, an error message can be issued and the fuel cell stack can be replaced.

According to a second aspect, the present invention relates to an operating method for operation of a possible embodiment of the fuel cell system presented.

The presented operating method comprises determining a composition of a gas flowing through an anode subsystem of the fuel cell system by means of measured values acquired by a pressure sensor in the anode subsystem, and controlling a flush valve of the fuel cell system according to the particular composition.

Further advantages, features, and details of the invention arise from the following description, in which exemplary embodiments of the invention are described in detail with reference to the drawings. In this context, the features mentioned in the claims and in the description can each be essential to the invention individually or in any combination.

### BRIEF DESCRIPTION OF THE DRAWINGS

Shown are:

FIG. 1 shows a schematic representation of one possible embodiment of the presented fuel cell system,

FIG. 2 shows a representation of possible pressure curves for different gas compositions in the anode subsystem of a fuel cell system,

FIG. 3 shows a schematic representation of one possible embodiment of the presented operating method,

FIG. 4 shows a detailed representation of one possible aspect of the presented operating method.

### DETAILED DESCRIPTION

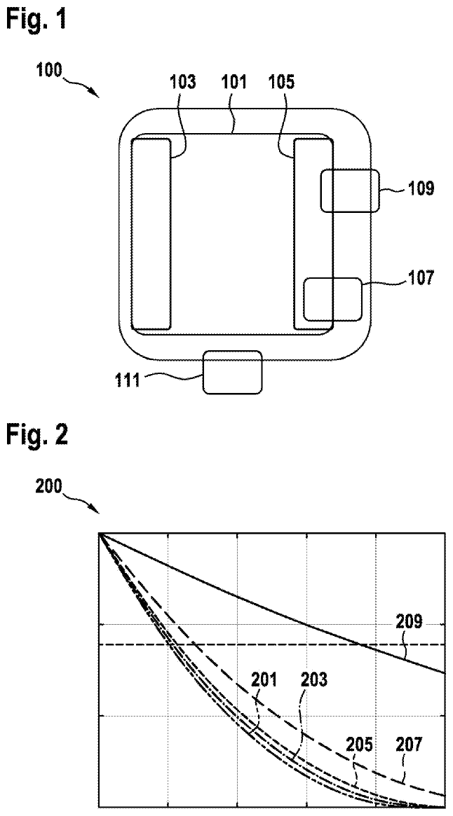

FIG. 1 shows a fuel cell system 100. The fuel cell system 100 comprises a fuel cell stack 101 comprising a cathode subsystem 103 and an anode subsystem 105, a pressure sensor 107 arranged in the anode subsystem 105, a flush valve 109 for flushing the anode subsystem 105, and a computing unit 111.

The computing unit 111 is configured to determine a composition of gas flowing through the anode subsystem 105 by means of measured values acquired by the pressure sensor 107, in particular with regard to substance quantity fractions of hydrogen and/or nitrogen, to control the flush valve 109 as a function of the substance quantity fractions.

For this purpose, the computing unit 111 can, for example, comprise a memory in which a characteristic diagram or a mapping diagram 200 according to FIG. 2 is stored.

The mapping diagram 200 includes a plurality of curves 201, 203, 205, 207, and 209 each associated with different gas compositions.

For example, the curve 201 corresponds to a gas of pure hydrogen, the curve 203 to a gas of 90% hydrogen and 10% nitrogen, the curve 205 to a gas of 80% hydrogen and 20% nitrogen, the curve 207 to a gas of 50% hydrogen and 50% nitrogen, and the curve 209 to a gas of pure nitrogen.

Accordingly, respective measured values acquired by the pressure sensor 107 may be associated with one of the curves 201, 203, 205 207 or 209 and, as a result, mapped to a gas composition.

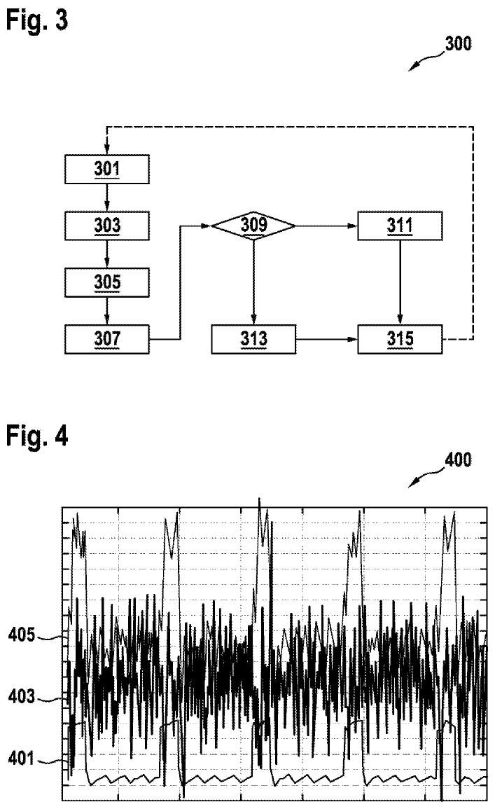

An operating method 300 for operating a fuel cell system is shown in FIG. 3. The operating method 300 comprises an opening step 301 in which a flush valve of the fuel cell system is opened, a measurement step 303 in which a pressure in an anode subsystem of the fuel cell system is measured, a closing step 305 in which the flush valve is closed, and a determination step 307 in which a composition of a gas in the anode subsystem is determined by values acquired in the measurement step 303.

In a balancing step 309, a quantity of at least one component of the composition determined in the determination step 307 is compared to a specified threshold value. For example, if the quantity of hydrogen is too high, a flushing interval, i.e. a duration for which a flush valve of the fuel cell system is activated, is decreased in a first adjustment step 311. For example, if the quantity of nitrogen is too high, a flushing interval, i.e. a duration for which a flush valve of the fuel cell system is activated, is increased in a second adjustment step 313.

In a final storage step 315, the flushing interval determined in the first adjustment step 311 or the second adjustment step 313 is stored and used as the standard value for a subsequent flushing operation.

FIG. 4 shows a diagram 400 with time represented on the X-axis and pressure on the Y-axis, as well as a control variable and a pilot control value.

A curve 401 shows the change in pilot control pressure of a hydrogen dosing valve of a fuel cell system over time.

A curve 403 shows the change in pressure in an anode subsystem of the fuel cell system over time.

A curve 405 shows the change in control corrections for a position of the hydrogen dosing valve over time.

It can be seen from diagram 400 that, despite a rapid increase in the pilot control pressure, during an opening operation of a flush valve, the hydrogen dosing valve opens with somewhat of a delay and a flatter slope.

Depending on the gas composition, or in the presence of liquid water, the controller may initially also move in the opposite direction. In this case, the pressure will not change for a brief moment, although the flush valve is already open. In this case, a lot of liquid water is in the anode subsystem, which can be discharged, for example, by a temporary increase in the activation frequency of the flush valve.

1. A fuel cell system (100) for converting energy,
wherein the fuel cell system (100) comprises the following:
a fuel cell stack (101) which comprises a cathode subsystem (103) and an anode subsystem (105),
a pressure sensor (107) which is arranged in the anode subsystem (105),
a flush valve (109) for flushing the anode subsystem (105),
a computer (111),
the computer (111) configured to determine a composition of a gas which is flowing through the anode subsystem (105) by means of measured values acquired by the pressure sensor (107) and to control the flush valve (109) according to the determined composition.

2. The fuel cell system (100) according to claim 1,
wherein
the computer (111) is configured to increase the period of time the flush valve (109) is activated compared to a prescribed standard value, or to decrease the period of time that the flush valve (109) is closed compared to a prescribed standard value, if a substance quantity fraction in the gas lies above a specified threshold value.

3. The fuel cell system (100) according to claim 1,
wherein
the computer (111) is configured to decrease the period of time the flush valve (109) is activated compared to a prescribed standard value, or to increase the period of time that the flush valve (109) is closed compared to a prescribed standard value, if a substance quantity fraction of hydrogen in the gas lies above a specified threshold value.

4. The fuel cell system (100) according to claim 1,
wherein
the computer (111) is configured to associate measured values acquired by the pressure sensor with a respective curve from among a predetermined plurality of curves for different compositions of gases.

5. The fuel cell system (100) according to claim 1,
wherein
the computer (111) is configured to calculate a quantity of hydrogen flowing into the anode subsystem (105) based on a position of a hydrogen dosing valve, a pressure differential between a position upstream of the hydrogen dosing valve to a position downstream of the hydrogen dosing valve, and the diameter of the area through which the inflowing hydrogen flows.

6. The fuel cell system (100) according to claim 5,
wherein
the computer (111) is further configured to adjust the quantity of hydrogen flowing into the anode subsystem (105) as a function of a substance quantity fraction of nitrogen in a gas flowing through the anode subsystem (105).

7. The fuel cell system (100) according to claim 1,
wherein
the fuel cell system (100) comprises a drain valve for draining water from the fuel cell system (100) and a hydrogen dosing valve,
wherein the computer (111) is configured to determine a quantity of liquid water located in the anode subsystem (105) based on a time curve of opening the hydrogen dosing valve during activation of the drain valve.

8. The fuel cell system (100) according to claim 7,
wherein
the computer (111) is configured to control the flush valve (109) as a function of the determined quantity of liquid water.

9. The fuel cell system (100) according to claim 7,
wherein
the computer (111) is configured to evaluate the determined quantity of liquid water over time, and in the event the determined quantity of liquid water decreases by more than a predetermined threshold value over time, to issue an error message, which includes a notification about the disturbance of water transport characteristics of the fuel cell system (100), and/or to adjust operating parameters of the fuel cell system (100) as a function of the determined quantity of liquid water.

10. An operating method (300) for operating a fuel cell system (100) according to claim 1,
wherein the operating method (300) comprises:
determining (301) a composition of a gas flowing through an anode subsystem (105) of the fuel cell system (100) by means of measured values acquired by a pressure sensor (107) in the anode subsystem (105), and controlling (303) a flush valve (109) of the fuel cell system (100) according to the determined composition of the gas.
